(19) United States
(12) Patent Application Publication
(10) Pub. No.: US 2010/0116216 A1
(43) Pub. Date: May 13, 2010

(54) Deep Sea Aquarium And Corresponding Operation Method

(76) Inventors: Gunter R. Fuhr, Berlin (DE); Heiko Zimmermann, Ingbert (DE)

Correspondence Address: Erickson Law Group, PC, 1749 S. NAPERVILLE ROAD, SUITE 202, WHEATON, IL, 60189, US

(21) Appl. No.: 12/439,534

(22) PCT Filed: Aug. 29, 2007
(86) PCT No.: PCT/EP2007/007551

§ 371 Date: Oct. 14, 2009

(30) Foreign Application Priority Data
Sep. 1, 2006 (DE) 10 2006 041 063.7
Jun. 15, 2007 (DE) 10 2007 027 643.7

(51) Int. Cl. A01K 63/00; A01K 61/00

(52) U.S. Cl. 119/221; 119/248; 119/250

(57) ABSTRACT

The invention relates to an aquarium with a water tank (2), filled with water (3) when in operation and containing objects for investigation (4, 19), in particularly biological organisms, said water tank (2) being at least partly located below ground in the earth (5). According to the invention, the water tank (2) runs so deep into the earth (5) that, at least the bottom of the water tank (2) is at the pressure of the deep sea. The invention further relates to a corresponding method of operation.

The invention relates to an aquarium and a corresponding operation method according to the independent claims.

For the accommodation and investigation of fish and other marine animals, aquaria are used which essential consist of a water tank which, in operation, is filled with water and receives the fish and marine animals to be accommodated.

A disadvantage of known aquaria is their lack of suitability for accommodating deep sea organisms which, in their natural environment in the deep sea, are adapted to a high water pressure corresponding to a water column of more than 1000 metres, and therefore cannot exist in an aquarium, due to the low water pressure prevailing therein.

Aquaria known as “deep sea aquaria” which are installed in public zoos for the display of fish and other marine animals are also known. However, the designation of these known aquaria as deep sea aquaria is misleading, since the water pressure in these aquaria does not in any way correspond to the deep sea pressure, so that these aquaria are also not suitable for accommodating deep sea organisms.

The investigation of deep sea organisms is therefore carried out with submarines in the deep ocean, although this is associated with various disadvantages. In the first place, the use of submarines for investigating deep sea organisms is extremely complex. Secondly, the use of submarines is time-limited, so that only investigations of deep sea organisms with a correspondingly short duration can be carried out.

It is therefore an object of the invention to provide a simple possibility for investigating deep sea organisms.

This aim is achieved with an aquarium according to the invention and a corresponding operation method according to the independent claims.

The invention includes the general technical teaching that the water tank of the aquarium according to the invention extends so deeply into the earth that at least the bottom of the water tank is at the pressure of the deep sea, enabling the investigation of deep sea organisms.

The expression “deep sea pressure” as used in the context of the invention preferably relates to a water column of more than 1000 m or even more than 2000 m. However, with regard to deep sea pressure, the invention is not limited to water columns of more than 1000 m, but also includes, for example, water tanks which contain a water column of more than 500 m, 250 m, 100 m, 50 m or even only more than 20 m. Accordingly, at the bottom of the aquarium according to the invention the pressure which prevails is more than 2 bar, 5 bar, 10 bar, 25 bar, 50 bar, 100 bar or even more than 200 bar.

A simple possibility for realising the aquarium according to the invention is to arrange the water tank in a mine shaft, a mine gallery or a mine cavern of an underground mine. Alternatively, however, a well shaft is also suitable for accommodating the water tank for the aquarium according to the invention.

The water tank can optionally be formed by a hollow underground space (e.g. a mine shaft) or can be arranged as a separate component in the hollow space.

The hollow space for accommodating the water tank for the aquarium according to the invention can also be a natural geological hollow space (e.g. a cave) or an artificially created hollow space (e.g. a mine shaft) in the earth.

Furthermore, the water tank in the aquarium according to the invention can be filled optionally with salt water or fresh water, depending on the organisms to be investigated.

The aquarium according to the invention described above has largely been described in this form in the parallel German patent application DE 10 2006 041 063, so that its entire content is to be considered part of the present description.

The present invention also solves a further problem. Firstly, some of the marine organisms accommodated by the aquarium can only live at a specific depth in the sea, since they have adapted to the pressure that prevails there. Secondly, some of these marine organisms have the capability of moving actively and would therefore move through different depth regions within the aquarium. Some of the marine organisms, on the other hand, due to a lack of their own mobility, would sink to the bottom of the aquarium, which does not correspond to the natural and appropriate environment of these marine organisms. The movement of the marine organisms in the aquarium can therefore lead to an impairment of these marine organisms.

It is therefore an object of the invention to solve the problems associated with the movement of the marine organisms in the aquarium.

This aim is achieved, according to the invention, with a control device which controls the movement of objects (e.g. marine organisms) and/or water in the water tank. In the context of this movement control, the control device is able to hinder (i.e. block), record and/or specifically guide movements of the objects and/or the water in the water tank.

In order to prevent movements in the water tank, the control device can have, for example, a barrier which is arranged in the water tank and at least partially stops the movement of objects (e.g. marine organisms, water, supply capsules) in the water tank.

In one embodiment of the invention, this barrier is size-selective in that it lets small objects (e.g. small marine animals) through and stops large objects (e.g. large fish).

For example, this size-selectivity of the barrier can be achieved in that the barrier consists of a grid with a particular mesh size, wherein the mesh size of the grid determines the size-selectivity of the barrier. The grid then holds back only those objects (e.g. fish) which are larger than the mesh size of the grid. Smaller objects (e.g. food material), however, can pass through the grid largely unhindered.

In an exemplary embodiment of the invention with a grid as the barrier, it is provided that the mesh size of the grid can be adjusted in order to influence the size-selectivity. For example, for this purpose, a plurality of grids can be arranged plane-parallel to one another and moveable relative to one another, in order to change the effective mesh size. The effective mesh size of this grid arrangement is a maximum when the grids are arranged relative to one another such that the meshes of both grids lie over and coincident with, one another. By contrast, the effective mesh size of this grid arrangement is minimal when the two grids are displaced relative to one another such that the grid nodes of one grid lie in the centre of the meshes of the other grid. Therefore, by means of a relative displacement of the two grids, the effective mesh size and thus also the size-selectivity of the barrier can be adjusted.

In another exemplary embodiment of the invention, the barrier in the water tank has an opening in order to allow passing of the barrier, for example, for sample removal. A scaring device is preferably arranged in the region of the opening in order to scare off biological organisms (e.g. dark-adapted deep sea organisms) from passing through the opening. For this purpose, the scaring device can emit, for example, intense light, electrical pulses, alternating electrical fields and/or electromagnetic radiation.

In a further embodiment of the invention the barrier in the water tank has a particular resistance force, so that the barrier stops objects having a small impact force (e.g. small deep sea fish), whereas the barrier allows through objects with a larger impact force (e.g. relatively heavy supply capsules).

It is also preferably provided in the context of the invention that the barrier is adjustable between a blocking position and a passing position, wherein, in the blocking position, the barrier blocks the movement of the objects, whereas in the passing position, it allows the objects to pass. For example, the barrier can be folded, rotated, pivoted or slid between the blocking position and the passing position.

The barrier can also cover the cross-section of the water tank either partially or fully.

For example, a plurality of barriers which reach across the whole cross-section of the water tank can be included in the water tank at different depths, thereby dividing the water tank into a plurality of depth zones.

Alternatively, it is possible for the barriers which are arranged over one another in the water tank each to cover only part of the cross-section of the water tank, wherein the barriers can be arranged offset in the peripheral direction. This offers the advantage that food material can sink from above to the base of the water tank, in order to supply marine organisms that have settled there.

The possibility also exists within the scope of the invention that the barrier in the water tank is semi-permeable in that the barrier is permeable to the water and to dissolved or suspended substances (e.g. food materials), whereas the barrier is impermeable to objects under investigation (e.g. marine organisms) or other objects.

The possibility also exists for the barrier to have an adjustable position in the water tank, allowing for flexible division of the space in the water tank. For example, the barrier can be specifically placed in the water tank to block side galleries of a mine.

It is also advantageous if the barrier has a viewing window or is made from a transparent material to enable visual monitoring through the barrier.

In one embodiment of the invention, the barrier is formed by terraces in the inner side wall of the water tank, wherein the individual terraces each comprise platforms for colonisation with marine organisms. The platforms advantageously prevent the colonising marine organisms from sinking down into the depth.

Alternatively, the possibility exists for the barrier to be formed by a platform floating in the water.

The concept of movement control as used within the scope of the invention is not limited to the prevention of movement in the water tank as explained above. Rather, this term also includes the detection of movements, for which purpose, for example, a movement sensor can be used.

It should also be noted that movement is preferably controlled in the vertical direction and/or in the horizontal direction.

It is evident from the statements above that the invention is not restricted only to an aquarium, but also includes a corresponding operation method.

Other advantageous embodiments of the invention are characterised in the subclaims or are described in greater detail below, together with the description of preferred embodiments of the invention, making reference to the drawings, in which:

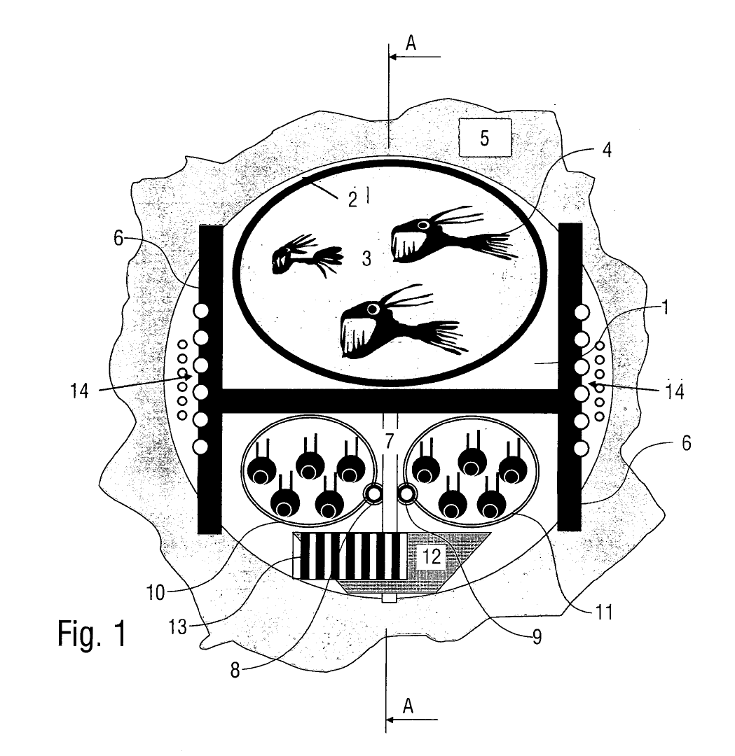

FIG. 1 shows a cross-sectional view of a mine shaft which has been converted according to the invention as a deep sea aquarium,

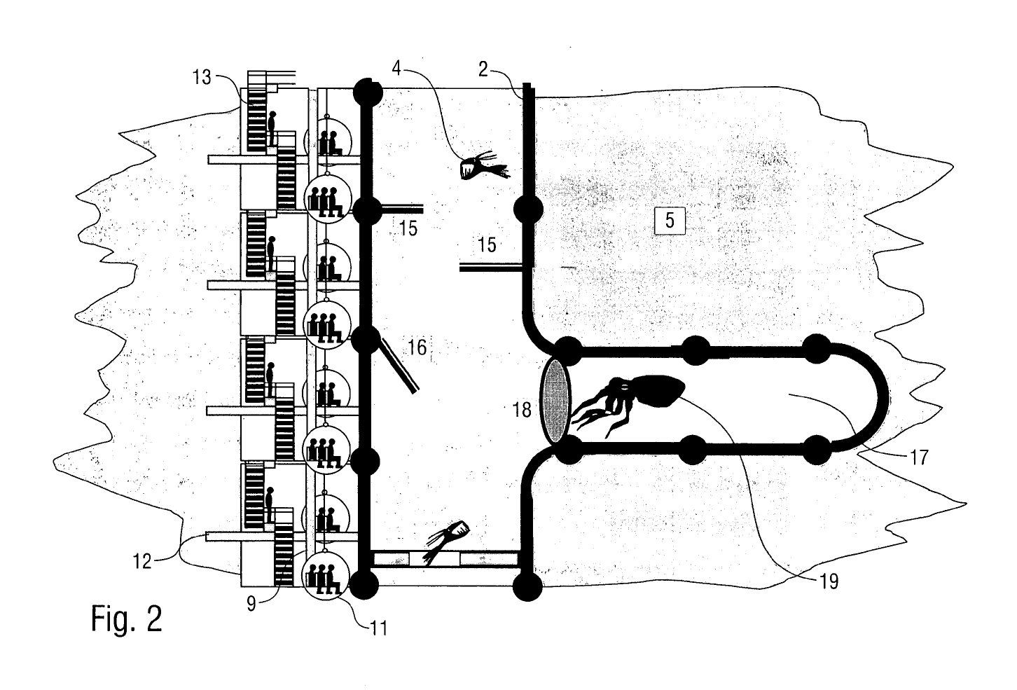

FIG. 2 shows a longitudinal section along the line A-A in FIG. 1,

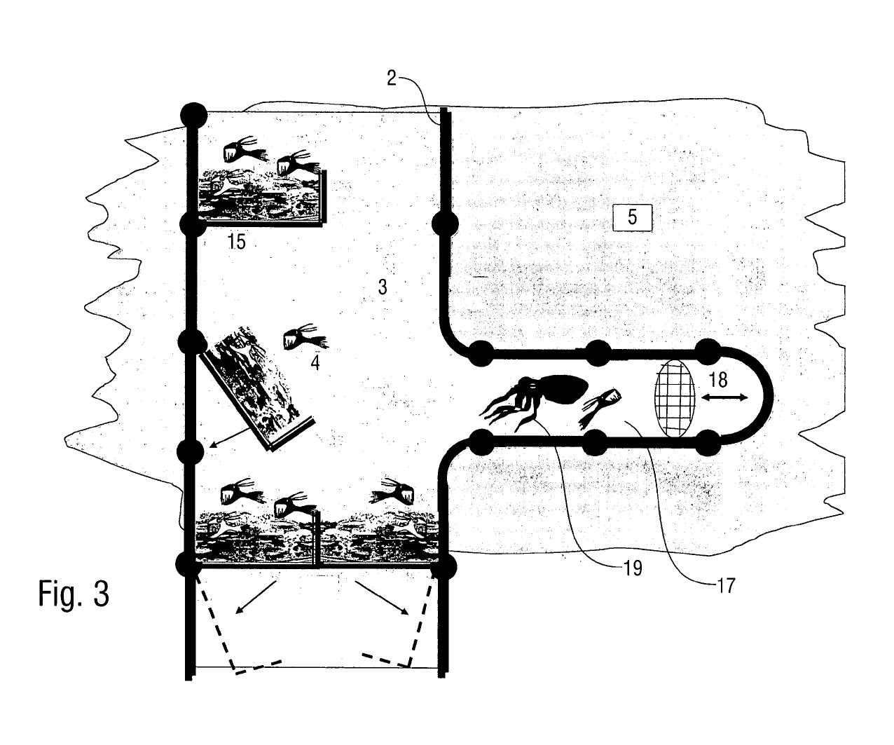

FIG. 3 shows a variant of the mine shaft converted as a deep sea aquarium of FIGS. 1 and 2,

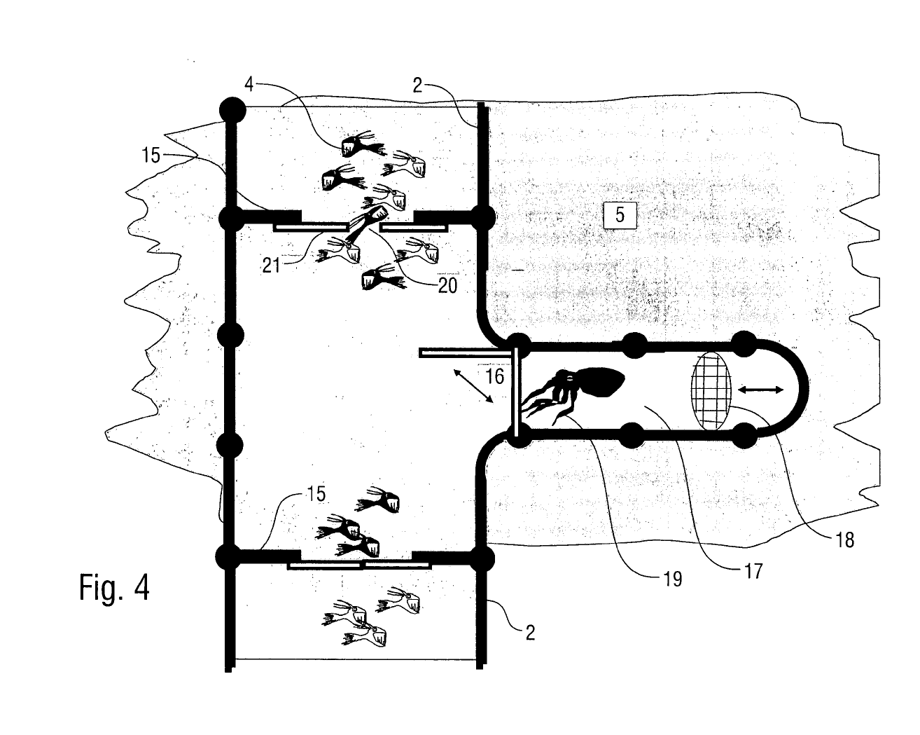

FIG. 4 shows a further variant of the mine shaft converted as a deep sea aquarium, which is divided by closable barriers into a plurality of depth zones,

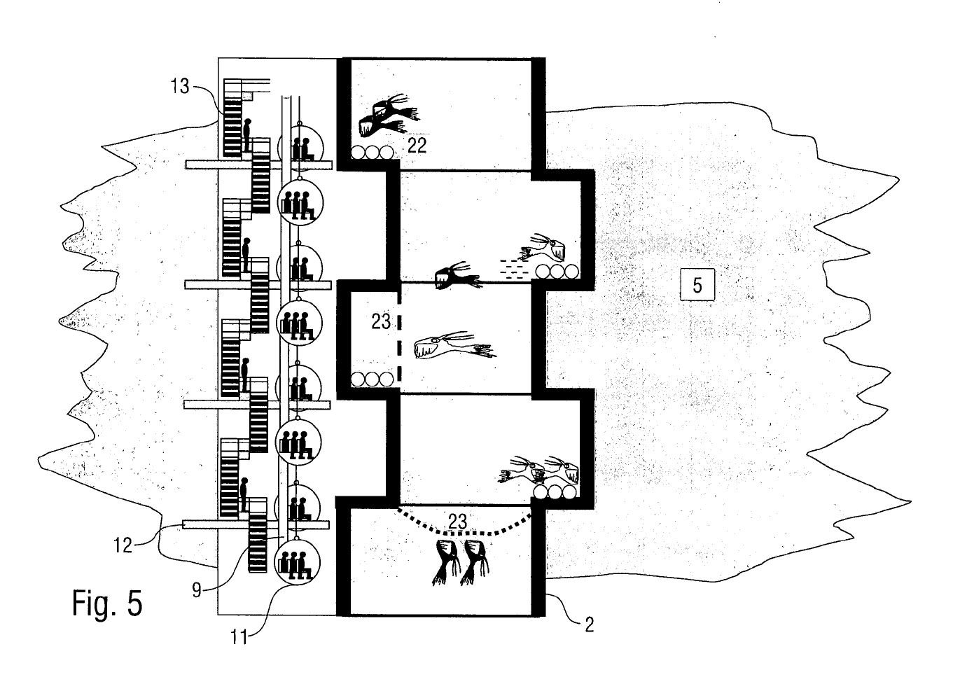

FIG. 5 shows a further variant of the mine shaft converted as a deep sea aquarium, wherein the mine shaft has terraces arranged laterally, which form platforms for colonisation by marine organisms,

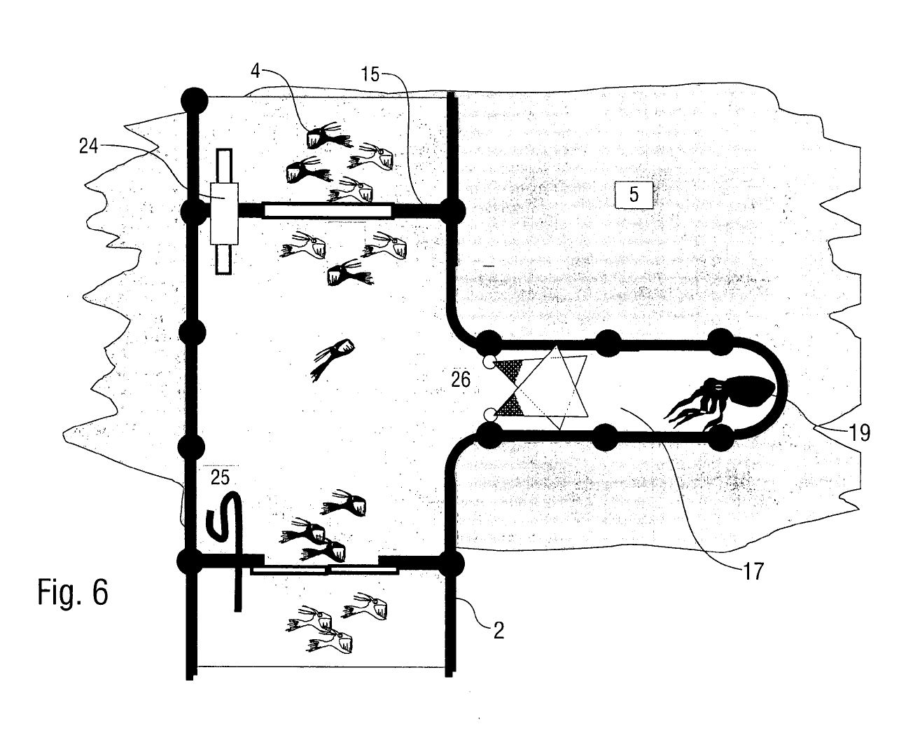

FIG. 6 shows a variant of the exemplary embodiment according to FIG. 4, wherein the barriers between the different depth zones are water-permeable,

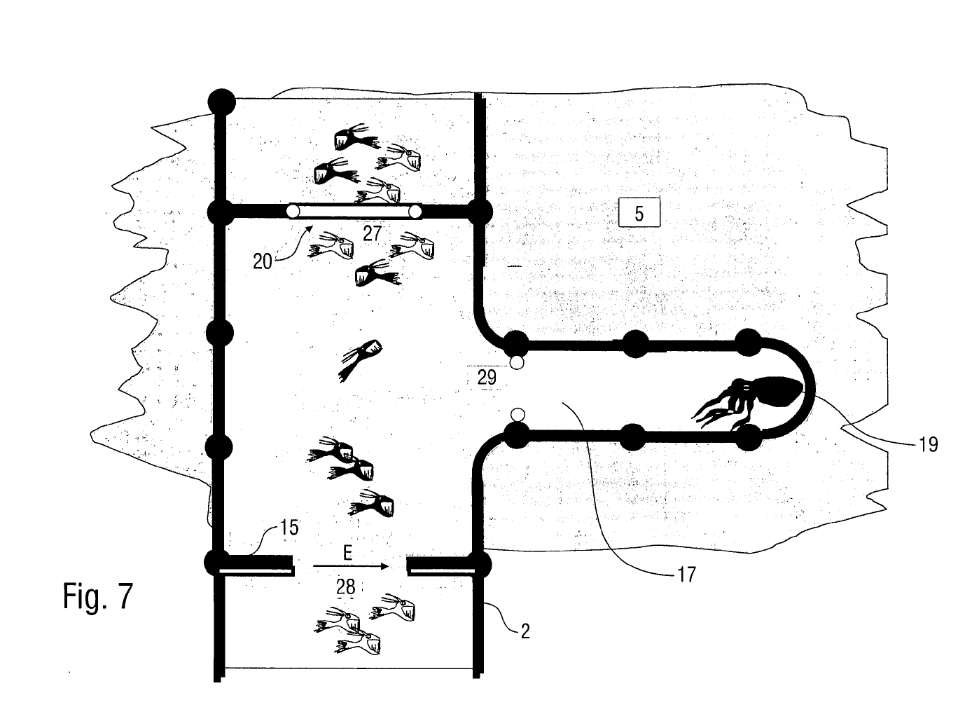

FIG. 7 shows a variant of the exemplary embodiment according to FIG. 4, with openings in the barriers between the adjacent depth zones, wherein the openings are illuminated in order to prevent dark-adapted deep sea organisms from passing, and

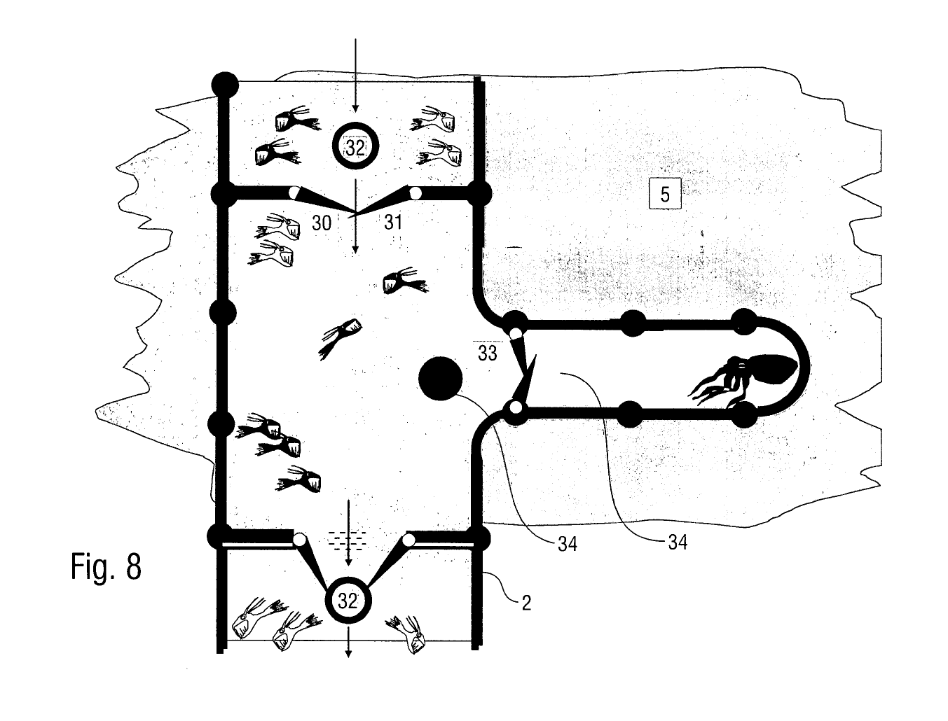

FIG. 8 shows a variant of the exemplary embodiment according to FIG. 4, wherein the barriers between the adjacent depth zones are permeable to supply capsules, which are able to sink downwardly from above through different depth zones.

FIGS. 1 and 2 show a mine shaft 1 converted as a deep sea aquarium and having a depth of several thousand metres, wherein the mine shaft 1 belongs to a shut-down underground mine in which mining is no longer carried out. This may be, for example, a shut-down coal or salt mine.

Arranged in the mine shaft 1 is a water tank 2 with an elliptical cross-section, wherein the water tank 2 extends from the earth's surface down to the base of the mine shaft 1 and, in this example, is filled with sea water 3 in order to accommodate marine animals 4 which are illustrated purely schematically here. The wall thickness of the water tank 2 is adapted to the pressure conditions according to the respective water depth. The wall thickness of the water tank 2 therefore increases from top to bottom in order to be able to withstand the great water pressure prevailing at the bottom of the water tank 2.

The remainder of the cross-section of the mine shaft 1 is filled, apart from the water tank 2, with air under atmospheric pressure, wherein the inner wall of the mine shaft 1 is walled off from the surrounding earth 5.

In addition, H-shaped steel supports 6 are inserted in the mine shaft 1 at spacings from a few metres to a few tens of metres. The water tank 2 is anchored to the steel supports 6 and is thereby mechanically stabilised in the mine shaft 1.

Arranged on the side of the steel supports 6 opposing the water tank 2 is a further steel support 7 with two vertically arranged guide rails 8, 9, on which lift gondolas 10, 11 can be respectively lowered or raised on cables for passenger transportation.

Also arranged over one another at regular spacings in the mine shaft 1 are rescue platforms 12, which can be reached via emergency exits in the lift gondolas 10, 11 and are connected to one another by means of stairs 13. In the event of a failure of the lift gondolas 10, 11, the persons in the lift gondolas 10, 11 can leave the lift gondolas via the respective emergency exit and reach the nearest rescue platform 12. From there, the persons can then leave the mine shaft 1 via the stairs 13.

Also arranged in the mine shaft 1 laterally beside the steel supports 6 are media lines 14 for electricity, air infeed, air outfeed, etc., wherein the media lines 14 extend in the mine shaft 1 from the earth's surface to the bottom of the mine shaft 1.

It is also apparent from the longitudinal sectional view in FIG. 2 that fixed barriers 15 and foldable barriers 16 are arranged in the water tank 2 at various depths. The fixed barriers 15 and, in their horizontal state, the foldable barriers 16 extend over part of the cross-section of the water tank 2 at different depths in the water tank 2 and prevent the larger marine animals 4 from sinking downwardly in the water tank 2.

In this exemplary embodiment, the barriers 15, 16 are configured as grids and have a particular mesh size, so that the water and small marine organisms, such as plankton, can pass through the barriers 15, 16 almost unhindered, whereas substantially larger marine animals 4 are stopped.

The longitudinal section in FIG. 2 also shows a side gallery 17 of the shut-down mine, wherein the side gallery 17 branches off laterally from the mine shaft 1. The mouth of the side gallery 17 in the mine shaft 1 is closed by a barrier 18 so that relatively large marine animals 19 can be enclosed in the side gallery 17.

The exemplary embodiment according to FIG. 3 accords with the exemplary embodiment described above and illustrated in FIGS. 1 and 2, so that in the interests of avoiding repetition, reference is made to the above description, wherein the same reference signs are used for matching details.

A particular feature of this exemplary embodiment lies therein that the foldable barriers 16 carry whole biotopes with sea bed formations and communities of organisms wherein the individual foldable barriers 16 extend asymmetrically and in sectors into the water tank 2.

The barriers 16 are herein configured trough-shaped in order to be able to accommodate the sea bed formations or communities of organisms.

It is herein important that the water tank 2 is not separated by the foldable barriers 16 into depth zones arranged one above the other and between which no exchange of water is possible. Rather, food material can pass from the top to the bottom of the water tank 2.

In this exemplary embodiment, the grid-shaped barrier 18 is arranged further back in the side gallery 17, so that the larger marine animals 19 can emerge forwardly out of the side gallery 17 into the water tank 2.

The exemplary embodiment according to FIG. 4 also accords substantially with the exemplary embodiments described above, so that in order to avoid repetition, reference is made to the above description, wherein the same reference signs are used for matching details.

A particular feature of this exemplary embodiment lies therein that the barriers 15 in the water tank 2 extend across the whole cross-section of the water tank 2 and therefore divide the water tank into several depth zones arranged over one another. Arranged in the individual barriers 15 is an opening 20 which can be optionally opened or closed by slide gates 21, wherein the size of the opening 20 can be adjusted steplessly by the slide gates 21 in order to allow only marine animals up to a particular freely selectable size to pass through.

Furthermore, the barrier 16 at the branch site of the side gallery 17 is configured as a folding closure so that the side gallery 17 can be optionally opened or closed.

Furthermore, in this embodiment, the slide gates 21 and the barriers 16 are made from a transparent material in order to enable visual control.

The exemplary embodiment according to FIG. 5 also agrees largely with the above described exemplary embodiments, so that, in order to avoid repetition, reference is made to the above description, wherein the same reference signs are used for matching details.

A particular feature of this exemplary embodiment lies therein that the water tank 2 is divided into several circular elements arranged over one another and offset laterally to one another, so that in each case, two horizontal platforms 22 are produced in the water tank 2, which can be colonised by marine organisms that are adapted to the respective depth.

Furthermore, individual niches can be separated in the water tank 2 by grids 23 in order that where marine organisms colonise the niches, they are protected from predators.

The exemplary embodiment according to FIG. 6 largely accords with the exemplary embodiment according to FIG. 4 so that, in order to avoid repetition, reference is made to the above description, wherein the same reference signs are used for matching details.

A particular feature of this exemplary embodiment consists therein that the barriers 15 each have a duct 24, 25 through which water can flow but which holds back the marine animals 4. The ducts 24, 25 can contain pipes, chambers and labyrinths, which, on the one hand, allow particular organisms to settle but, on the other hand, hinder vertical migration of organisms, but without preventing it entirely. In order to enable the sedimentation of food materials such as feedstuffs, a collecting funnel can also be placed on the duct 24, 25.

Furthermore, infrared sensors 26 are arranged at the branching site of the side gallery 17, in order to be able to detect the approach of marine animals 19.

The exemplary embodiment according to FIG. 7 largely accords with the exemplary embodiment according to FIG. 4 described above, so that, in order to avoid repetition, reference is made to the description above, wherein the same reference signs are used for matching details.

A particular feature of this exemplary embodiment consists therein that lamps 27 are arranged in the opening 20 of the barrier 15 in order to scare the dark-adapted deep sea organisms off from passing through the opening 20.

Arranged in the lower barrier 15 is an electrode arrangement 28 which emits strong electrical pulses or alternating fields and thereby also hinders the marine animals 4 from passing through the barrier 15.

Arranged at the branching point to the side gallery 17, in this exemplary embodiment, are strong lamps 29 which scare off the dark-adapted marine animals 19 situated in the side gallery 17 from swimming out of the side gallery 17 into the water tank 2.

Finally, the exemplary embodiment according to FIG. 8 accords substantially with the above described exemplary embodiments, so that, in order to avoid repetition, reference is made to the description above.

A particular feature of this exemplary embodiment is that the barriers 15 in the water tank 2 each have closure flaps 30, 31 which can fold downwardly in order to allow supply capsules 32 through, which can then sink to the bottom of the water tank 2. The closure flaps 30, 31 have a resistance force which is overcome on being impacted by one of the supply capsules 32, but which is sufficient to prevent the passage of the marine animals 4.

Suitable closure flaps 33 are also arranged at the opening site of the side gallery 17 and these can only be pushed through by a supply capsule 34.

The invention is not restricted to the above described preferred exemplary embodiments. Rather, several variants and developments are possible which also make use of the inventive concept and therefore fall within the scope of protection.

### REFERENCE NUMERALS

1 Mine shaft
2 Water tank
3 Sea water
4 Marine animals
5 Earth
6 Steel support
7 Steel support
8, 9 Guide rails
10, 11 Lift gondolas
12 Rescue platform
13 Stairs
14 Media lines
15 Fixed barriers
16 Foldable barriers
17 Side gallery
18 Barrier
19 Marine animals
20 Opening
21 Slide gate
22 Platform
23 Grid
24, 25 Duct
26 Infrared sensors
27 Lamps
28 Electrodes
29 Lamps
30, 31 Closure flaps
32 Supply capsule
33 Closure flaps
34 Supply capsule

1. An aquarium comprising a water tank which, in operation, is filled with water and contains objects for investigation, wherein the water tank is arranged at least partially underground in the earth and reaches so deep into the earth that there is deep sea pressure at least at the bottom of the water tank.

2. The aquarium according to claim 1, wherein a control device controls the movements of the objects under investigation in the water tank.

3. The aquarium according to claim 1, wherein a control device
controls the movements of the water in the water tank.

4. The aquarium according to claim 2, wherein the control device prevents movements in the water tank.

5. The aquarium according to claim 2, wherein the control device records movements in the water tank.

6. The aquarium according to claim 2, wherein the control device guides movements in the water tank.

7. The aquarium according to claim 2, wherein the control device has at least one barrier, which is arranged in the water tank and at least partially stops the movement of objects in the water tank.

8. The aquarium according to claim 7, wherein the barrier is size-selective in that it allows small objects through and stops large objects.

9. The aquarium according to claim 8, wherein the barrier comprises at least one grid with a particular mesh size, wherein the mesh size of the grid determines the size-selectivity of the barrier.

10. The aquarium according to claim 9,
b) electrical pulses,
wherein the mesh size of the grid is adjustable.

11. The aquarium according to claim 10, wherein the barrier comprises a plurality of grids arranged plan-parallel to one another and movable relative to one another in order to change the effective mesh size.

12. The aquarium according to claim 7, wherein the barrier has an opening, arranged in the region of which is a scaring device, in order to scare biological organisms off from passing through the opening.

13. The aquarium according to claim 12,
wherein the scaring device emits a signal selected from a group consisting of:
a) light,
b) electrical pulses,
c) alternating electrical fields,
d) electromagnetic radiation.

14. The aquarium according to claim 7, wherein the barrier has a particular resistance force, so that the barrier stops objects having a small impact force, whereas the barrier lets through objects with a larger impact force.

15. The aquarium according to claim 7, wherein the barrier is adjustable between a blocking position and a passing position, wherein, in the blocking position, the barrier blocks the movement of the objects, whereas, in the passing position, the barrier allows the objects to pass.

16. The aquarium according to claim 15, wherein the barrier can be moved between the blocking position and the passing position by a movement, wherein the movement is selected from a group consisting of:
a) folding,
b) rotating,
c) sliding,
d) pivoting.

17. The aquarium according to claim 15, wherein, at least in the blocking position, the barrier partially covers the cross-section of the water tank.

18. The aquarium according to claim 15, wherein, at least in the blocking position, the barrier fully recovers the cross-section of the water tank.

19. The aquarium according to claim 7, wherein the barrier is semi-permeable in that the barrier is permeable to the water and to dissolved or suspended substances contained therein, whereas the barrier is impermeable to the objects under investigation.

20. The aquarium according to claim 7, wherein the barrier has an adiustable position in order to enable flexible division of the space in the water tank.

21. The aquarium according to claim 20, wherein the barrier is displaceable in the water tank.

22. The aquarium according to claim 7, wherein the barrier is at least partially transparent to enable visual monitoring.

23. The aquarium according to claim 7, wherein the barrier is formed by terraces in the inner side wall of the water tank, wherein the terraces comprise platforms for colonisation with organisms.

24. The aquarium according to claim 7, wherein the barrier is formed by a platform which floats in the water.

25. The aquarium according to claim 2, wherein the control device comprises at least one movement sensor, which detects movements in the water tank.

26. The aquarium according claim 2, wherein the control device controls movement in the vertical direction and/or the horizontal direction.

27. The aquarium according to claim 1, wherein, the water tank is arranged in an underground hollow space in the earth.

28. The aquarium according to claim 1, wherein the water tank is formed by an underground hollow space in the earth.

29. The aquarium according to claim 27, wherein the hollow space is selected from a group consisting of:
a) a mine shaft,
b) a mine gallery,
c) a mine cavern,
d) a well shaft.

30. The aquarium according to claim 27, wherein the underground hollow space is selected from a group consisting of:
a) a natural geological hollow space,
b) an artificially created hollow space in the earth.

31. The aquarium according to claim 1, wherein, in the filled condition, the water tank contains a vertical water column with a height exceeding a minimum level which is selected from a group consisting of 20 m, 50 m, 100 m, 250 m, 500 m, 1000 m.

32. The aquarium according to claim 1, wherein the water tank is filled with salt water.

33. The aquarium according to claim 1, wherein the water tank is filled with fresh water

34. The aquarium according to claim 1, wherein the objects for investigation are biological organisms.

35. Operation method for an aquarium comprising the following steps:
a) filling a water tank with water, wherein the water tank is arranged at least partially underground in the earth and extends so deeply into the earth that there is deep sea pressure at least at the bottom of the water tank.
b) placement of objects for investigation in the water tank.

36. Operation method according to claim 35, further comprising the following step:
controlling the movements of the objects under investigation and/or of the water in the water tank.

37. Operation method according to claim 36, wherein in the context of the control, movements in the water tank are hindered.

38. Operation method according to claim 36, wherein in the context of the control, movements in the water tank are recorded.

39. Operation method according to claim 36, wherein in the context of the control, movements in the water tank are guided.

40. Operation method according to claim 36, wherein the movement of the objects is controlled depending on the properties of the objects.

41. Operation method according to claim 31, wherein the control takes place depending on the properties which are selected from a group consisting of:
a) object mass,
b) object size,
c) object type.

42. Operation method according to claim 35, further comprising the following step:
adjustment of at least one barrier in the water tank, in order to optionally stop or allow movements.

43. Operation method according to claim 42, wherein the barrier comprises a grid arrangement with an adjustable mesh size, wherein the mesh size is adjusted in order to optionally stop or allow movements.

44. Operation method according to claim 35, wherein the water tank comprises a barrier with an opening, wherein biological organisms are scared off from passing through the opening.

45. Operation method according to claim 35, wherein, in order to scare off the organisms, a signal is emitted which is selected from a group consisting of:
a) light,
b) electrical pulses,
c) alternating electrical fields,
d) electromagnetic radiation.

46. Use of a hollow space in an underground mine as a water tank for an aquarium.
